(19) United States
(12) Patent Application Publication
(10) Pub. No.: US 2004/0255827 A1
(43) Pub. Date: Dec. 23, 2004

(54) Tray for transporting vehicle wheels and/or wheel rims, and associated assembly and support

(75) Inventor: Pedro Leite de Barros JR., Limeira (BR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Meritor do Brasil LTDA.

(21) Appl. No.: 10/800,839

(22) Filed: Mar. 15, 2004

(30) Foreign Application Priority Data
Jun. 9, 2003 (BR) PI0301727-3

(51) Int. Cl. B62M 1/14

(52) U.S. Cl. 108/55.1

(57) ABSTRACT

A tray apparatus for transporting a vehicle wheel/wheel rim is provided. At least two complementarily arranged first support members each have a first guide-and-positioning element, the respective first elements cooperating to define a first accommodation region for receiving one side of a first wheel/wheel rim. At least two complementarily arranged second support members separate first and second wheels/wheel rims to prevent damage, and each have at least one second guide-and-positioning element on each side. The second elements on one side define a second accommodation region for receiving the other side of the first wheel/wheel rim. The second elements on the other side define a third accommodation region for receiving one side of the second wheel/wheel rim. The accommodation regions constrain lateral movement of the wheels/wheel rims with respect to the support members and allow the wheels/wheel rims to be packaged side-by-side. An associated assembly and device are also provided.

### BACKGROUND OF THE INVENTION

1. Field of the Invention

The present invention relates to a tray for accommodating and transporting wheels and/or wheel rims of different diameters and configurations, as well at to an assembly formed by the tray and wheels and/wheel rim, and to a support for use with this tray.

2. Description of Related Art

Conventionally, vehicle wheels are transported from the factory to their final destination (at the vehicle assembly factories) on trays, also known as pallets, where a plurality of wheel are positioned so that the wheel will not touch the neighboring wheels, which might damage the painting of both of them. In order to enable one to stack wheels, which maximizes the amount that may be carried on a single tray, spaced-apart small stops are provided, positioned on the flange wheels, so that a wheel positioned above another wheel will touch only this spacer, thus preventing scratches on the paining, which would certainly occur due to the movement during the transport.

Another possibility of avoiding scratches on the painting of stacked wheels is the use of cardboard partitions or the like between the wheels.

Both situations have drawbacks, namely:

1) In the case of using the spacers, the big drawback is the need to use a large number thereof (preferably four spacers per wheel), which need to be manually positioned and fitted on the flanges of each wheel, in order to allow another wheel to be stacked without touching the next one directly. The need to mount each spacer manually is a factor that reduces the speed of stacking the wheels and, consequently, completing the trays, which culminates in considerably reducing the speed of sending the produced wheels to the vehicle manufacturer.

Another disadvantage of this system is that, since each spacer is a small component provided with delicate claws, it may be easily lost/damaged, and so there is a need to replace it constantly, which entails additional costs that may not be disregarded.

2) In the case of using cardboard partitions, the positioning is no longer a problem, since the partition is positioned over the wheels, thus enabling one to accommodate further wheels, without their touching those located below. However, the problem of reduced useful life of the partition remains and, moreover, the use thereof imparts an appearance of improvisation and permits movements of the wheels to the sides.

With a view to achieve a solution to the problem of side movement of the wheels, document WO96/24530 discloses a tray for accommodating wheels having recesses that define circumferences of varied diameters with common stretches, thus enabling one to transport the wheel, including those of different diameters, without side movement taking place. However, this solution has the drawback of requiring much material to make the tray, which increases its market value due to the large thickness necessary to make the layers for fitting the wheels. Besides, the problem of the need for a spacer or a partition that enables one to stack the wheels is not solved.

Document DE4339445 discloses a tray having several configurations of guides for accommodating wheels, including those of different diameters. These guides prevent the rims from moving to the sides, besides fitting them into the tray, and they are configured so as to permit little flexibility with regard to the sizes of diameters of the wheels to be transported. However, this tray does not solve the problem of the need for a spacer or partition to enable one to stack wheels.

Japanese document JP8026283 discloses a tray for accommodating and transporting automotive wheels, which has grooves in its surface corresponding to the diameters of the wheels to be transported. These grooves are configured in such a way that the tray can receive and accommodate wheels of different diameters, without allowing them to move to the sides. The difficulty encountered in this solution is the configuration of the grooves, which requires steps of high manufacture cost. In addition, this solution does not solve the problem of the need for a spacer or partition that will enable one to stack wheels either.

Until now, nobody had proposed a tray having a support to prevent the wheels to be transported from moving to the sides and enabling one to stack wheels without contact between them that might cause damage to them.

Accordingly, one objective of the present invention is to provide an easy-to-use tray for transporting and stacking wheels and wheel rims, with a low manufacture cost, which enables one to transport wheel rims and vehicle wheels, prevents them from moving to the sides and enables one to stack them, without their touching each other, which might cause damage to them.

A second objective of the present invention is to provide an assembly of tray and wheels or wheel rims that brings about the above-mentioned advantages.

Another objective of the present invention is to provide a support for use with the above-described tray and assembly.

### BRIEF SUMMARY OF THE INVENTION

The objectives of the present invention are achieved by means of a tray, particularly for transporting vehicle wheels and/or vehicle-wheel rims, provided with at least one substantially planar structure and at least two first supports, each of the first supports comprising at least one first guide-and-positioning element, the two first supports being associated to the structure in a cooperative way, the first guide-and-positioning elements of the associated two first supports defining at least one first region for horizontal accommodation of at least one vehicle wheel/vehicle-wheel rim, the tray further comprising at least two second supports, each of the second supports comprising at least one second guide-and-positioning element associable to a horizontally accommodated wheel/wheel rim and at least one third guide-and-positioning element, the two supports being associable to the wheel/wheel rim so that the third guide-and-positioning elements will define at least one second region for horizontal accommodation of at least one wheel/wheel rim.

The objectives of the present invention are also achieved by means of an assembly of tray and wheels and/or wheel rims, provided with at least one wheel/wheel rim and at least one tray formed by at least one substantially plane structure and at least two first supports, each of the first supports comprising at least one first guide-and-positioning element, the two first supports being associated to the structure in a cooperative way, the first guide-and-positioning elements of the two associated first supports defining at least one first region for horizontal accommodation of vehicle wheel/vehicle-wheel rim, the tray further comprising at least two second supports, each of the second supports comprising at least one second guide-and-positioning element associated to the horizontally accommodated wheel/wheel rim and at least one third guide-and-positioning element, the second two supports being associated to the wheel/wheel rim so that the third guide-and-positioning elements will define at least a second region for horizontal accommodation of at least one wheel/wheel rim.

Further, the objectives of the present invention are achieved by means of a support, particularly for use with a tray for transporting vehicle wheels and/or vehicle-wheel rims, as defined above, having the shape of a substantially rectangular plate and comprising a first main surface provided with a plurality of guide-and-positioning elements arranged as semicircular projection.

The present invention has the following advantages, among others:

possibility of transporting vehicle-wheel rims and vehicle wheels, which are easily stacked and without the risk of the wheels colliding with each other, which might cause damage to the painting;

possibility of stacking a large number of wheels;

no need to use small plastic spacers, which might be easily lost/damaged;

long durability of the supports, by virtue of their large size.

### BRIEF DESCRIPTION OF THE SEVERAL VIEWS OF THE DRAWING(S)

The present invention will now be described in greater detail with reference to an embodiment represented in the drawings. The figures show:

FIG. 1 is a perspective view of the tray for transporting wheels and/or wheel rims of the present invention;

FIG. 2 is a perspective view in detail of the tray illustrated in FIG. 1;

FIG. 3 is a top view of the tray for transporting wheels and/or wheel rims of the present invention, prepared for stacking wheels;

FIG. 4 is a perspective view in detail of the tray of the present invention containing stacked wheels;

FIG. 5 corresponds to a bottom view of the second tray support according to the present invention; and

FIG. 6 corresponds to a top view of the second tray support according to the present invention.

### DETAILED DESCRIPTION OF THE INVENTION

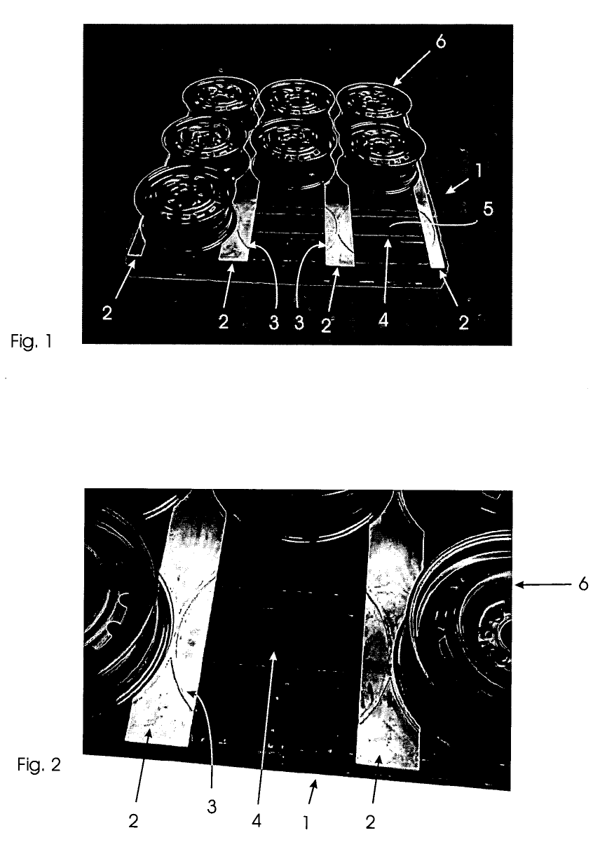

According to a preferred embodiment and as can be seen in FIG. 1, the tray 1 of the present invention for fitting vehicle components such as wheels and wheel rims comprises a substantially planar structure 5 and at least two first supports 2 and two second supports 2′ for enabling one to accommodate at least two vehicle wheels 6 or vehicle-wheel rims in a horizontally stacked way.

The structure or structural element 5 is substantially rectangular in shape and is preferably formed by a plurality of joined wooden lathes, but it is evident that the constitution thereof may vary. Alternatively, one may conceive a structure of a polymeric material or any other possible configuration. Preferably, but not compulsorily, the structure 5 has at least one recess (not illustrated) to correctly position a stacking spear, which enables the vehicle to take the tray 1 out of and put it in the desired place, as for instance on a truck or even to move it along an industrial plant. Evidently, the structure may assume any other necessary and/or desirable configuration, as long as it is functional, without the resultant tray departing from the scope of protection of the present invention.

Whatever the embodiment, the structure 5 has at least two, but preferably four, first supports 2, which are associated to it so that they will cooperate two by two with each other, as will be explained in detail later. Evidently, the number of first supports 2 may vary, as necessary or desirable.

Each first support 2 substantially has the shape of a rectangular plate, defining a first main surface or side and having a length considerably larger than its width and, preferably but not compulsorily, equivalent to the length of the structure 5.

The first main surface is the one which is not facing the structure 5 and has at least one, but preferably a plurality of first guide-and-positioning elements 3.

The first guide-and-positioning elements 3 have the function of correctly positioning the wheel/wheel rim 6 on the structure 5, preventing it from moving to the sides (laterally with respect to the supports), which would cause the wheel to touch the neighboring one (this would cause damage to the painting of the wheels). The preferred shape presented by the first guide elements 3 (which will hereinafter be called guides 3) is that of a semicircular projection, with a diameter only fractionally larger than the diameter of the wheel/wheel rim 6 to be accommodated.

It should be noted that the wheels/wheel rims 6 are positioned in a horizontal way, that is to say, the flange of one of their sides will be facing the structure 5. In this way devices that prevent it from moving angularly are not necessary, due to this positioning. Evidently, the shape of the first guides 3 may be any shape, as long as it is functional, that is to say, it should enable one to position and fix the wheel/wheel rim 6 correctly, preventing it from moving to the sides. Alternatively, the first guides 3 may assume other configurations, such as annular segments, punctual projections or any other.

Whatever their shape, the first guides 3 correspond to projections that extend from the first main surface of each first support 2.

The preferred embodiment of the tray 1 of the present invention comprises four main supports 2, positioned substantially parallel to each other, so that two supports will be located at the longitudinal ends of the structure 5 and two supports will be located between them. As a result, the first support 2 and the neighboring one define a region (accommodating region) for horizontal accommodation 4 of a wheel/wheel rim 6, which is delimited by the first guides 3 of these supports. So, in the preferred embodiment, the two adjacent first supports 2 define three regions 4 for horizontal accommodation of the wheel/wheel rim.

As can be seen in FIGS. 1 and 2, the preferred embodiment of the present invention has two types of first supports 2, namely, the two supports that will be located at the ends of the structure 5, each of which has three first guides 3 and configures a first end support; and the two supports that are located between the end supports, each of which having six first guides 3 arranged adjacently three by three and configuring a first intermediate support.

FIG. 2 shows a first intermediate support 2, with the two first adjacent guides 3 being shaped as a semicircular or arcuate projection, which have opposing open ends. Evidently, this results from the fact that each first intermediate support 2, by means of its first guides 3, enables one to position six wheels/wheel rims 6, three of each with one of the adjacent supports. The first intermediate supports are then similar to two side by side end supports, since the first guides 3 arranged adjacent to each other are facing opposite direction.

In the case of the first end supports 2, since they have only one adjacent support, they do not need to have the three additional first guides 3.

However, the configuration of the supports may evidently vary. Alternatively, it is possible to provide the a tray 1 having four identically configured supports 2, wherein even the end supports would have eight first guides 3, or else any other possible configuration, as long as the first resulting supports 2 enable one to accommodate wheel/wheel rims 6 in such a way that they will not move horizontally.

Preferably, the first supports 2 are made from a polymeric material, as for example polyethylene, but it is evident that this material may be replaced by any other functional material, such as other polymers, metals or even wood.

Also, one may configure a first support 2, on which the first guides 3 do not correspond to the projections that extend from its first surface, but rather to recesses located in this same surface.

It should be further noted that one may provide a tray 1 according to the teachings of this invention, wherein the first supports 2 are integral part of the structure 5, independently from their embodiment and number.

As mentioned before, the tray 1 of the present invention further has at least two, but preferably a plurality of, second supports 2′, very similar to the first supports 2 described above, the main functions of which are to enable one to stack wheels/wheel rims 6 (increasing the transport capacity of the tray 1 disclosed now), without the latter touching each other, and to prevent the wheels/wheel rim from moving to the sides, a situation that might cause damage to the painting of the wheels, generating rejection of the buyer and, therefore, considerable losses.

In order to enable one to stack wheels/wheel rims 6, it is necessary that all the regions for horizontal accommodation defined by the first supports 2 be accommodating wheels/wheel rims, and all of the accommodated wheels/wheel rims must have the same width, due to reasons that will be explained later.

The preferred embodiment of the tray 1 object of the present invention comprises four second supports 2′, each of them having substantially the shape of a rectangular plate, defining a first main surface 7 and a second main surface 7′ opposite to the first one, and having a length considerably larger than its width. Preferably, the length of the second supports 2′ is equivalent to the length of the structure 5 and of the first supports 2.

The second supports 2′ are placed over the wheels/wheel rims 6, which occupy the first regions of horizontal accommodation 4 already mentioned, where they can play the role for which the are designed (and which has already been informed above), namely, to enable one to stack wheels/rims on those wheels/rims already horizontally accommodated, without their touching each other, and to prevent them from moving to the sides. If the accommodated wheels/rims 6 have different widths, it will not be possible to rest the second supports 2′ because, since the wheels are horizontally accommodated, a wheel/wheel rim having a larger width will be higher. This might make unfeasible to rest the second supports 2′.

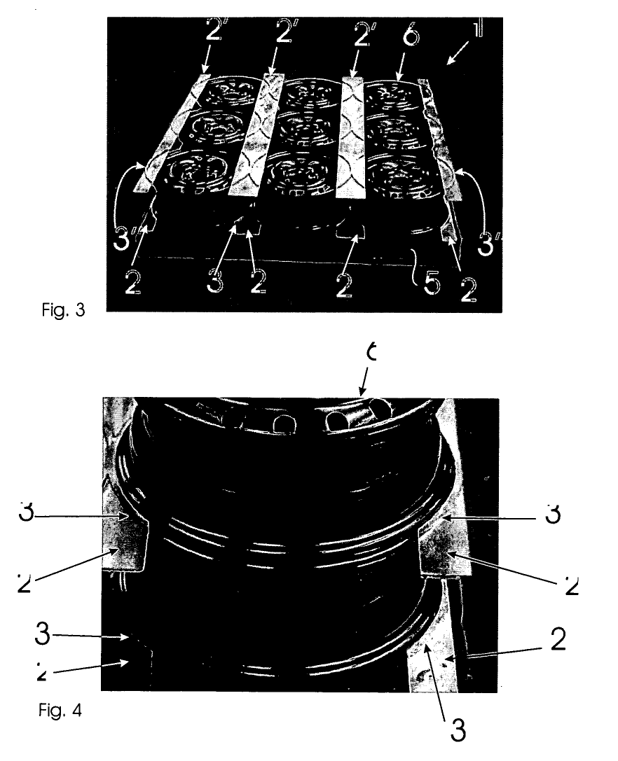

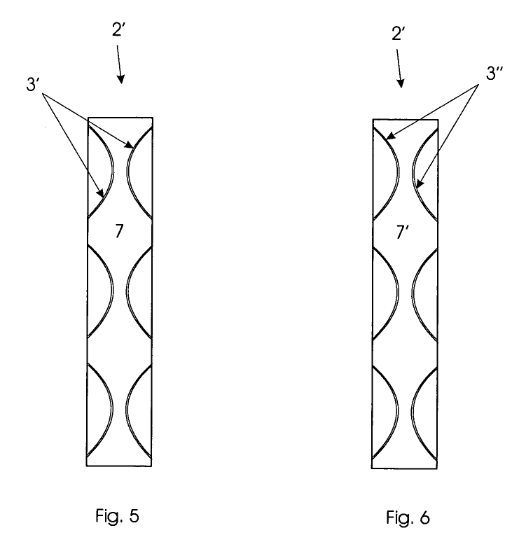

Considering a second support 2′ already positioned over the wheels/wheel rims, as illustrated in FIGS. 3 to 6, their first main surface 7 is that facing the already positioned wheel/rims (and ultimately facing the structure 5), and their second surface 7′ opposite the first one is that on which other wheels/wheel rims 6 will be accommodated.

The first surface of the second support 2′ has second guide-and-positioning elements 3′, preferably in a number and positioning identical to those of the first guides 3 of the corresponding first supports 2. This is necessary, since these second guides 3′, located on the first surface 7, cooperate with the already accommodated wheels/wheel rims. Evidently, the shapes and positioning of the second guides 3′ may vary, as long as they bring about an effect identical to that which would be achieved if the guides were identical to the first guides 3.

In case the second guides 3′ of the first surface 7 of the second support 2′ have any differences that prevent an effect identical to that achieved by the first guides 3 of the corresponding first support 2, it would not be possible to position/fit the second support correctly at the already accommodated wheels/rims.

The second surface 7′ of the second supports 2′, which, as already mentioned, is opposed the first one, also has a plurality of third guides 3″, positioned so as to enable one accommodate wheels/wheel rims 6 stacked on the already accommodated wheels/wheel rims.

Preferably, the number and arrangement of the third guide-and-positioning elements 3″, which extend from the second surface 7′, are identical to those of the second guides 3′ and, therefore, analogous to the first guides 3, which extend from the first supports 2. Evidently, however, the shape and number of the third guides 3″, which extend from the second surface 7′ of the second supports, may vary, as long as they are functional.

Therefore, in the preferred embodiment, the second supports 2′ have all the third guides 3″ in a form of a semicircular projection, with a diameter just fractionally larger than the diameter of the wheels/wheel rims to be accommodated. Preferably, the tray 1 has two second supports 2′ located at the longitudinal ends of the structure 5 and two second supports 2′ located in the space defined between them. So, a second support 2′ and its neighbor define a second region for horizontal accommodation of a wheel/wheel rim, which is delimited by the third guides 3″ of these second supports. Thus, in the preferred embodiment, two adjacent second supports 2 define three regions for horizontal accommodation of a wheel/wheel rim. Is should be noted that these characteristics are also presented by the first supports 2, for which they have already been described.

As can be seen in FIGS. 3 and 4, the preferred embodiment of the present invention has two types of second supports 2′, namely: the two supports that are located at the ends of the structure 5, each of which having four third guides 3″ and configuring a second end support; and the two supports that are located between the two end supports, each of which having eight third guides 3″ arranged adjacent to each other four by four and configuring a second intermediate support.

As can be seen in FIG. 3, the two adjacent third guides 3″ of the second support 2′ in an intermediate location have the shape of a semicircular projection, with opposed open ends. Evidently, this results from the fact that each second intermediate support 2′, by means of its third guides 3″, enables the positioning of six wheels/wheel rims 6, three wheels with each of the adjacent second supports. The second intermediate supports 2′ are then similar to two second end supports side by side, since the third guides 3″ that are arranged adjacent are facing opposite directions. All the information relating to variations of the guides that project from the first and second surfaces 7, 7′ of the second supports 2′ are analogous to those presented by the first guides 3 of the first supports 2; so they will not be repeated.

Preferably, the second supports 2′ are made from a polymeric material, as for example polyethylene, but it is evident that this material may be replaced by any other functional material, such as other polymers, metals or even wood. One may also configure a second support 2′, on which the guides do not correspond to projections extending from its first and second surfaces 7, 7′, but rather to recesses located in these same surfaces.

One may also foresee the existence of third supports (not illustrated), analogous to the second supports 2′, which enable one to stack one further level of wheels/wheel rims, as well as the existence of other additional supports, analogous to the second supports 2′, which enable one to stack a plurality of wheels/wheel rims, thus maximizing the storage capacity of the tray 1.

The tray described herein and loaded with wheels/wheel rims, correctly stacked and separated from each other by means of first and second supports 2, 2′ described now, is called an assembly of tray and wheels/wheel rims, which is also an aimed invention and is included in the scope of protection of the claims. Further, the support 2, 2′ used on the tray 1 herein revealed is also included in the scope of protection of the claims.

A preferred embodiment having been described, one should understand that the scope of the present invention embraces other possible variations, being limited only by the contents of the accompanying claims, which include the possible equivalents.

That which is claimed:

1. A tray apparatus adapted to transport a plurality of vehicle components, each vehicle component having opposing sides and comprising at least one of a vehicle wheel and a vehicle wheel rim, said tray apparatus comprising:
at least two first support members;
at least one first guide-and-positioning element operably engaged with each first support member, the respective first guide-and-positioning elements being configured to cooperate to define a first accommodation region therebetween for receiving one side of a first vehicle component when the first support members are disposed in a complementary arrangement with respect to each other;
at least two second support members each having opposing sides and capable of separating the first vehicle component from a second vehicle component so as to prevent damage to the respective vehicle components; and
at least one second guide-and-positioning element operably engaged with each side of each second support member, the respective second guide-and-positioning elements on one side of the second support members being configured to cooperate to define a second accommodation region therebetween for receiving the other side of the first vehicle component, and the respective second guide-and-positioning elements on the other side of the second support members being configured to cooperate to define a third accommodation region therebetween capable of receiving one side of the second vehicle component, when the second support members are disposed in the complementary arrangement with respect to each other, the accommodation regions cooperating so as to constrain lateral movement of the vehicle components with respect to the support members, and thereby allowing the vehicle objects to be packaged in a side-to-side relation.

2. A tray apparatus according to claim 1 further comprising a substantially planar structural member capable of being operably engaged with the first support members so as to support the support members and the vehicle components.

3. A tray apparatus according to claim 1 wherein the first and second support members are each configured as a substantially rectangular plate.

4. A tray apparatus according to claim 1 wherein the first and second guide-and-positioning elements are each configured as an arcuate projection extending from the respective support member and defining a concave area, the concave areas of the respective guide-and-positioning elements being disposed in opposing relation to define the corresponding accommodating region when the respective support members are disposed in the complementary arrangement.

5. A tray apparatus according to claim 1 wherein the first and second guide-and-positioning elements are each configured as a semi-circular depression extending into the respective support member and defining a concave area, the concave areas of the respective guide-and-positioning elements being disposed in opposing relation to define the corresponding accommodating region when the respective support members are disposed in the complementary arrangement.

6. A tray apparatus according to claim 1 wherein, when disposed in the complementary arrangement, the respective first and second support members are disposed in substantially parallel relation to each other.

7. A transportable assembly for at least one vehicle component, each vehicle component having opposing sides and comprising at least one of a vehicle wheel and a vehicle wheel rim, said transportable assembly comprising:
at least one vehicle component;
a substantially planar structural member;
at least two elongate first support members capable of being operably engaged with the structural member so as to be supported thereby;
at least one first guide-and-positioning element operably engaged with each first support member, the respective first guide-and-positioning elements being configured to cooperate to define a first accommodation region therebetween for receiving one side of a first of the at least one vehicle component when the first support members are disposed in a complementary arrangement with respect to each other;
at least two elongate second support members each having opposing sides and capable of separating the first vehicle component from a second of the at least one vehicle component so as to prevent damage to the respective vehicle components; and
at least one second guide-and-positioning element operably engaged with each side of each second support member, the respective second guide-and-positioning elements on one side of the second support members being configured to cooperate to define a second accommodation region therebetween for receiving the other side of the first vehicle component, and the respective second guide-and-positioning elements on the other side of the second support members being configured to cooperate to define a third accommodation region therebetween capable of receiving one side of the second vehicle component, when the second support 20 members are disposed in the complementary arrangement with respect to each other, the accommodation regions cooperating so as to constrain lateral movement of the vehicle components with respect to the support members, and thereby allowing the vehicle objects to be packaged in a side-to-side relation.

8. A transportable assembly according to claim 7 wherein the first support members are integral with the structural member such that the respective first guide-and-positioning elements extend from the structural member and define the first accommodation region therebetween.

9. A transportable assembly according to claim 7 wherein the first and second support members are each configured as substantially rectangular plate.

10. A transportable assembly according to claim 7 wherein the first and second guide-and-positioning elements are each configured as an arcuate projection extending from the respective support member and defining a concave area, the concave areas of the respective guide-and-positioning elements being disposed in opposing relation to define the corresponding accommodating region when the respective support members are disposed in the complementary arrangement.

11. A transportable assembly according to claim 7 wherein the first and second guide-and-positioning elements are each configured as a semi-circular depression extending into the respective support member and defining a concave area, the concave areas of the respective guide-and-positioning elements being disposed in opposing relation to define the corresponding accommodating region when the respective support members are disposed in the complementary arrangement.

12. A transportable assembly according to claim 7 wherein, when disposed in the complementary arrangement, the respective first and second support members are disposed in substantially parallel relation to each other.

13. A support device adapted to protect a vehicle component from damage, the vehicle component having opposing sides and comprising at least one of a vehicle wheel and a vehicle wheel rim, said support device comprising:
an elongate support member adapted to separate the vehicle component from at least one of a structural element and another vehicle component, so as to prevent damage to the vehicle component; and
at least one guide-and-positioning element operably engaged with at least one side of the support member, wherein, when two support members are disposed in a complementary arrangement with respect to each other, the respective guide-and-positioning elements cooperate to define an accommodation region therebetween for receiving one side of the vehicle component, the accommodation region thereby constraining lateral movement of the vehicle component with respect to the support members.

14. A support device according to claim 13 wherein the support member is configured to be capable of operably engaging a substantially planar structural member so as to be supported thereby.

15. A support device according to claim 13 wherein the support member is configured as a substantially rectangular plate.

16. A support device according to claim 13 wherein the at least one guide-and-positioning element is configured as an arcuate projection extending from the support member and defining a concave area, the concave areas of the guide-and-positioning elements being disposed in opposing relation to define the accommodating region when the support members are disposed in the complementary arrangement.

17. A support device according to claim 13 wherein the at least one guide-and-positioning element is configured as a semi-circular depression extending into the support member and defining a concave area, the concave areas of the guide-and-positioning elements being disposed in opposing relation to define the accommodating region when the support members are disposed in the complementary arrangement.

18. A support device according to claim 13 wherein, when disposed in the complementary arrangement, the two support members are disposed in substantially parallel relation to each other.
